(19) United States
(12) Patent Application Publication
(10) Pub. No.: US 2020/0231211 A1
(43) Pub. Date: Jul. 23, 2020

(54) SUBFRAME OF A MOTOR VEHICLE

(71) Applicant: AUDI AG, Ingolstadt (DE)

(72) Inventor: Sven SCHMALZRIETH, Ingolstadt (DE)

(73) Assignee: AUDI AG, Ingolstadt (DE)

(21) Appl. No.: 16/652,745

(22) PCT Filed: Oct. 16, 2018
(86) PCT No.: PCT/EP2018/078227

§ 371 Date: Apr. 1, 2020

(30) Foreign Application Priority Data
Nov. 8, 2017 (DE) 10 2017 219 859.1

(51) Int. Cl. B62D 21/03; B62D 27/06; B62D 21/15

(52) U.S. Cl. CPC B62D 21/03; B62D 21/155; B62D 27/06

(57) ABSTRACT

The disclosure relates to a subframe of a motor vehicle, including two front function nodes and two rear function nodes as considered in the vehicle longitudinal direction, wherein at least two function nodes are connected by at least one crossmember, and the front function nodes are connected to the rear function nodes by two longitudinal members, wherein the function nodes are formed with bearing receptacles into which rubber-metal bearings for connection to the body are pressed, and wherein stop plates are arranged on the rubber-metal bearings by screw connections. In at least one stop plate for one of the rubber-metal bearings is formed as an assembly support.

The present invention relates to a subframe for a motor vehicle of the type indicated according to the preamble of claim 1.

Subframes for motor vehicles of various types are known from the prior art. Thus, DE 10 2005 045 295 B4, for example, comprises an open subframe for a motor vehicle comprising two front and two rear function nodes, wherein the front function nodes are connected by means of a crossmember element, and two longitudinal member elements connect the front function nodes to the rear function nodes.

To this end, subframes are used to preassemble partial areas of a motor vehicle and to insert the preassembled unit into the body of the vehicle and to connect thereto. Not only vehicle components such as, for example, a wheel suspension or hydraulic assemblies for vehicle steering are attached to the subframe, but also the engine is supported on the subframe. Furthermore, the body is directly attached to the subframe. The subframe thereby contributes to stability and crash safety.

The function nodes of a subframe are used, inter alia, for connection to the body. The connection is implemented by means of rubber-metal bearings which are penetrated by a fastening screw. The rubber-metal bearings are pressed into corresponding recesses of the subframe and have an inner sleeve and an outer sleeve, wherein an elastic intermediate layer is arranged between the inner sleeve and outer sleeve. A solid stop plate is provided on the periphery of the elastic part. Said stop plate is arranged between the subframe and the head of the fastening screw and extends from the inner sleeve radially outward; cf. DE 199 01 299 C1. The stop plate limits axial suspension travel of the rubber-metal bearing and enables soft support of the subframe in its vertical main direction of loading.

EP 1 188 643 A1 describes a triangular stop plate, which is refined as a connecting structure between the subframe and the body. DE 10 2006 036 852 A1 discloses a truncated conical stop plate designed as an adapter, said stop plate being formed as an endpiece of a stiffening element and serving as a connection between the subframe and the stiffening element.

The object of the invention is to refine a subframe of the type indicated in the preamble of claim 1 to the extent that the geometry of the subframe is simplified.

This object is achieved by the characterizing features of claim 1 in conjunction with its preamble features.

The dependent claims form advantageous enhancements of the invention.

In a known way and manner, the subframe for a motor vehicle comprises four function nodes, wherein—as considered in the vehicle longitudinal direction—the two front function nodes are connected by means of a crossmember, and two longitudinal members connect the front function nodes to the rear function nodes. The function nodes form the mounting points for the subframe bearings. The outer sleeve of such a rubber-metal bearing is connected to the subframe, and the core is connected to the body. A connection layer in the form of an elastomer is disposed between the core and the outer sleeve. The core is attached to the body by means of a screw, wherein a stop plate is clamped between the core and the screw.

According to the invention, it is provided that at least one stop plate of a rubber-metal bearing is designed such that it simultaneously serves as an assembly support. As compared to the conventional attachment of the assembly support, this function-integrating connection reduces the number of connection points on the body. The attachment, according to the invention, of the stop plate formed as an assembly support is implemented by means of a previously existing connection point on the function node which has strong rigidity outside the member geometry of the subframe. This hereby makes it possible, in an advantageous manner, to use a lighter and thus more economical subframe, which still fulfills the functional requirements.

Preferably, the stop plate has a through-hole, which is formed such that the connection to the core of the bearing is implemented by means of a screw connection. The screw connection extends through the stop plate designed for the assembly support, the rubber-metal bearing of the subframe, as well as the body. The stop plate is hereby used as a limit of the travel of the subframe, which oscillates due to the elastic coupling. By means of the integrating connection of the assembly support, which simultaneously is used as the stop plate, the complexity of the subframe is reduced in an advantageous manner.

According to a preferred embodiment of the stop plate according to the invention, it may have further connection mounting points. It is conceivable that connection points are formed to the body and/or to the traction battery. These connection points may refine the stop plate to the extent that an additional load path develops particularly early on in the event of initiation of load due to an accident. A head-on collision with an obstacle when the vehicle is traveling forward may cause, for example, the rearward displacement of the stop plate according to the invention in the vehicle longitudinal direction, wherein the steering wheel is impacted and deformed in the area of the connection. A rearward shifting of the steering wheel occurs, wherein the center of rotation of the front wheel is shifted rearward in the vehicle longitudinal direction before displacement and inward rotation of the front wheel due to the accident. Serious intrusions in a bulkhead area disposed behind the front wheel can hereby be avoided; cf. DE 10 2012 024 145 A1. Thus, a force path forms by means of the stop plate formed for the assembly support, said force path having a supporting contribution in the distribution of energy in the event of an impact.

It is conceivable that the assembly support according to the invention is arranged at one or more function nodes. It is also possible that the assembly support is attached with a conventional attachment by means of the connection according to the invention in a composite design.

Further advantages and application options of the present invention result from the following description in conjunction with the exemplary embodiments shown in the figures.

The following is shown:

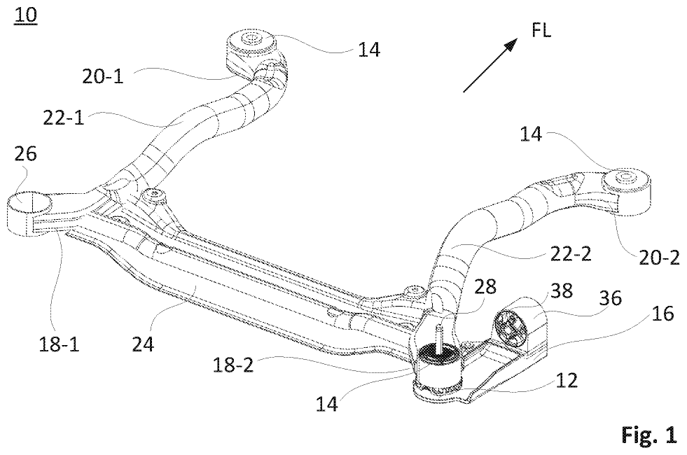

FIG. 1 a lateral top view of a subframe of a motor vehicle with a mounted stop plate;

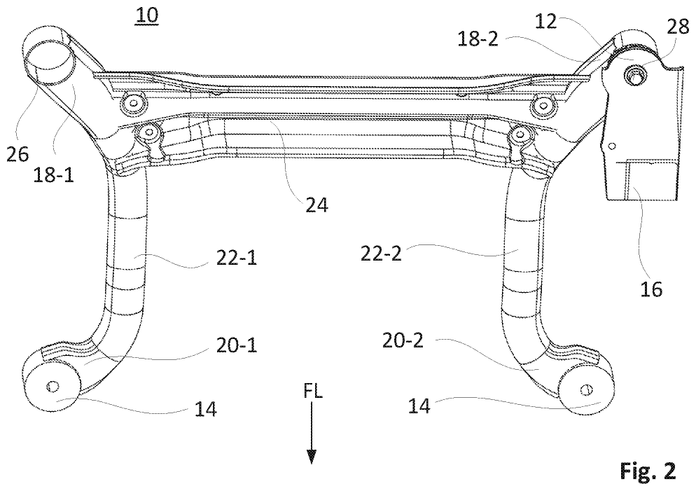

FIG. 2 a view of the subframe according to FIG. 1 from below; and

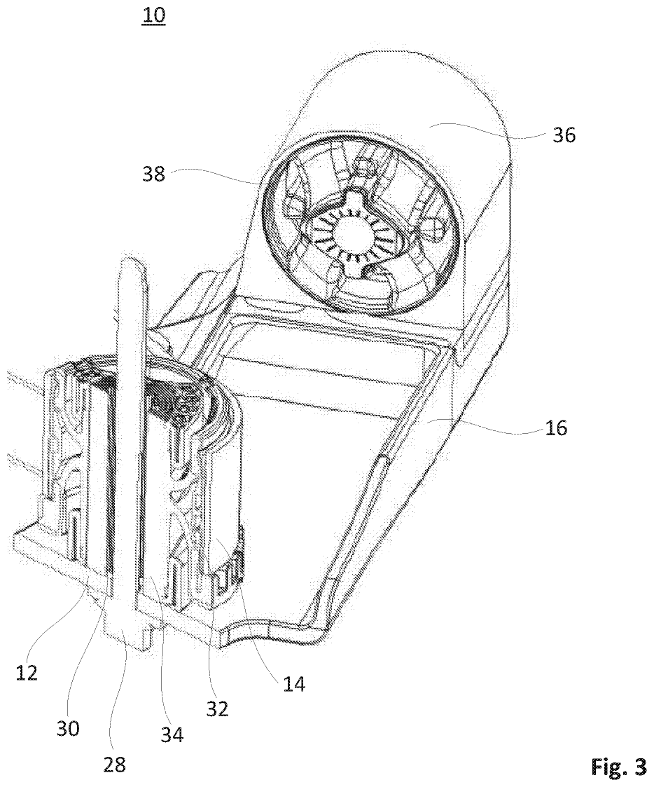

FIG. 3 a detailed view of the mounted stop plate.

FIGS. 1 to 3 show, in a schematic view, a subframe, generally characterized with reference numeral 10, for a motor vehicle, in which a stop plate 12 for a rubber-metal bearing 14 is formed as an assembly support 16.

According to the embodiment shown in FIGS. 1 and 2, the subframe 10 comprises a motor vehicle, as considered in the vehicle longitudinal direction FL, two front function nodes 18-1, 18-2, and two rear function nodes 20-1, 20-2, which are connected by means of two longitudinal members 22-1, 22-2, wherein the front function nodes 18-1, 18-2 are connected by means of a crossmember 24. The function nodes 18-1, 18-2, 20-1, 20-2 have recesses 26, into which the rubber-metal bearings 14 are pressed, which are used for connecting to the body by means of screw connections 28.

As shown in FIG. 3, the rubber-metal bearings 14 have an inner sleeve 30 and an outer sleeve 32, with an elastic intermediate layer 34 being arranged in between. The outer sleeve 32 is connected to the subframe, which is not shown here, wherein the inner sleeve 30 is connected to the body. A stop plate 12 is arranged between the head of the screw connection 28 and the bottom of the subframe 10 and extends from the inner sleeve 30 outward radially. The stop plate 12 limits the suspension travel of the rubber-metal bearing 14 on the bottom of the elastic intermediate layer 34, particularly the travel from the subframe to the body.

FIGS. 1 to 3 show the stop plate 12 of the rubber-metal bearing 14, which is designed as an assembly support 16 in a function-integrating manner, which is formed as a console-style supporting part here, to the extent that it has at least one bearing eyelet (36) for mounting a bearing core (38), which is connectable to the assembly. The locally dynamic strength of the function nodes 18-1, 18-2, 20-1, 20-2 enables the connection of the function-integrated assembly support 16. It can be connected to any of function nodes 18-1, 18-2, 20-1, 20-2. The connection of the assembly support 16 is implemented by means of a screw connection 28, which mounts the subframe 10 to the body by means of the function nodes 18-1, 18-2, 20-1, 20-2. The screw connection 28 extends through the stop plate 12/assembly support 16, the rubber-metal bearing 14 of the subframe 10, as well as the body.

The assembly support 16 may also have further connection mounting points, which are formed, for example, as connection points to the body and/or to the traction battery. These connection points may refine the stop plate 12 such that an additional load path develops in the event of an impact. Thus, the embodiment according to the invention of the stop plate 12 formed for the assembly support 16 supports the transmission of forces in the event of an impact.

1-7. (canceled)

8. A subframe of a motor vehicle, comprising:
two front function nodes and two rear function nodes as considered in the vehicle longitudinal direction, wherein at least two function nodes are connected by at least one crossmember, and the front function nodes are connected to the rear function nodes by two longitudinal members, wherein the function nodes are formed with bearing receptacles into which rubber-metal bearings for connection to the body are pressed, and wherein stop plates are arranged on the rubber-metal bearings by screw connections,
wherein at least one stop plate for at least one of the rubber-metal bearings is formed as an assembly support.

9. The subframe according to claim 8, wherein the connection of the assembly support to the function nodes is implemented by a common screw connection extending through the through-hole and the rubber-metal bearings.

10. The subframe according to claim 8, wherein the assembly support is formed as a console-style supporting part.

11. The subframe according to claim 8, wherein the assembly support has at least one bearing core, which is connectable to an assembly, in at least one bearing eyelet.

12. The subframe according to claim 8, wherein the assembly support is formed with a bearing eyelet, into which a bearing is pressed, which is connected to the assembly via its bearing core.

13. The subframe according to claim 8, wherein the assembly support has at least one further mounting point.

14. The subframe according to claim 12, wherein the further mounting point is formed as a connection point to the body and/or to the traction battery.

15. The subframe according to claim 9, wherein the assembly support is formed as a console-style supporting part.

16. The subframe according to claim 9, wherein the assembly support has at least one bearing core, which is connectable to an assembly, in at least one bearing eyelet.

17. The subframe according to claim 10, wherein the assembly support has at least one bearing core, which is connectable to an assembly, in at least one bearing eyelet.

18. The subframe according to claim 9, wherein the assembly support is formed with a bearing eyelet, into which a bearing is pressed, which is connected to the assembly via its bearing core.

19. The subframe according to claim 10, wherein the assembly support is formed with a bearing eyelet, into which a bearing is pressed, which is connected to the assembly via its bearing core.

20. The subframe according to claim 11, wherein the assembly support is formed with a bearing eyelet, into which a bearing is pressed, which is connected to the assembly via its bearing core.

21. The subframe according to claim 9, wherein the assembly support has at least one further mounting point.

22. The subframe according to claim 10, wherein the assembly support has at least one further mounting point.

23. The subframe according to claim 11, wherein the assembly support has at least one further mounting point.

24. The subframe according to claim 12, wherein the assembly support has at least one further mounting point.
